(19) United States
(12) Patent Application Publication
(10) Pub. No.: US 2007/0058385 A1
(43) Pub. Date: Mar. 15, 2007

(54) Illuminating wheel rims

(76) Inventor: Kuo Bin Chen, Yangmei Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/227,747

(22) Filed: Sep. 15, 2005

(51) Int. Cl. B60Q 1/26

(52) U.S. Cl. 362/500; 362/192

(57) ABSTRACT

A wheel rim includes a generator connected thereto which is activated by a magnet which rotates across coils and electric capacitors in the generator so as to produce electrical power. A plurality of light emitting diodes (LEDs) are connected to the rim and electrically connected to the generator such that when the rim rotates, the LEDs emit light to catch people's attentions.

### FIELD OF THE INVENTION

The present invention relates to a vehicle wheel rim with generator and light emitting diodes (LEDs) which provide illumination feature when the wheels are rotating.

### BACKGROUND OF THE INVENTION

A conventional wheel rim 30 is shown in FIG. 7 and generally includes a peripheral engaging portion 32 on which a tire (not shown) is mounted and the engaging portion 32 includes a smooth inner surface. The conventional wheel rim does not provide any illumination function so that attentions cannot be caught in normal or emergency situation.

The present invention intends to provide a vehicle wheel rim which includes a generator which powers a plurality of LEDs connected to the rim so that people's attentions can be caught by the LEDs at dark area and this increases response time for other drivers and pedestrians to avoid accidents.

### SUMMARY OF THE INVENTION

The present invention relates to a wheel rim which comprises a peripheral engaging portion so as to fix a tire thereon and a central ring. A plurality of ribs are connected between the central ring and the periphery of the rim. A generator is connected to the central ring and includes coils and electric capacitors. A rotatable member is rotatably connected to a central axle of the generator so as to activate the coils to produce electric power. A plurality of light emitting diodes (LEDs) are connected to the rim and electrically connected to the generator.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wheel rim of the present invention;

FIG. 2 is a side view of the wheel rim of the present invention;

FIG. 3 shows the generator of the wheel rim of the present invention;

FIG. 4 is an exploded view to show the generator of the wheel rim of the present invention;

FIG. 5 is a front view of a second embodiment of the wheel rim of the present invention;

FIG. 6 shows a side view of the wheel rim in FIG. 5 of the present invention;

FIG. 6-1 shows the connection of an LED and the plate of the wheel rim in FIG. 5 of the present invention, and

FIG. 7 shows a conventional wheel rim.

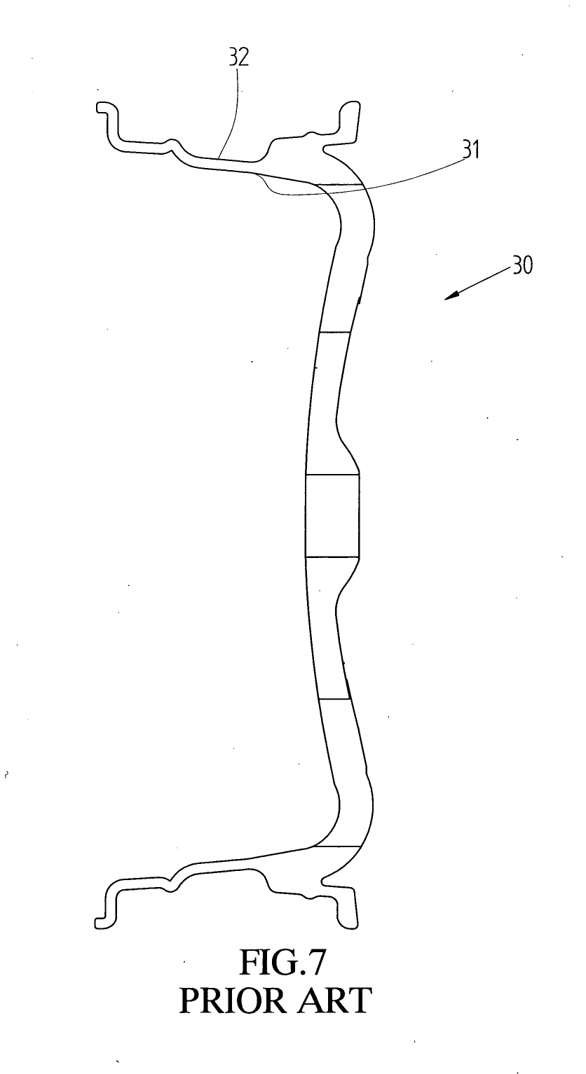

### DETAILED DESCRIPTION OF THE PREFERRED EMBODIMENT

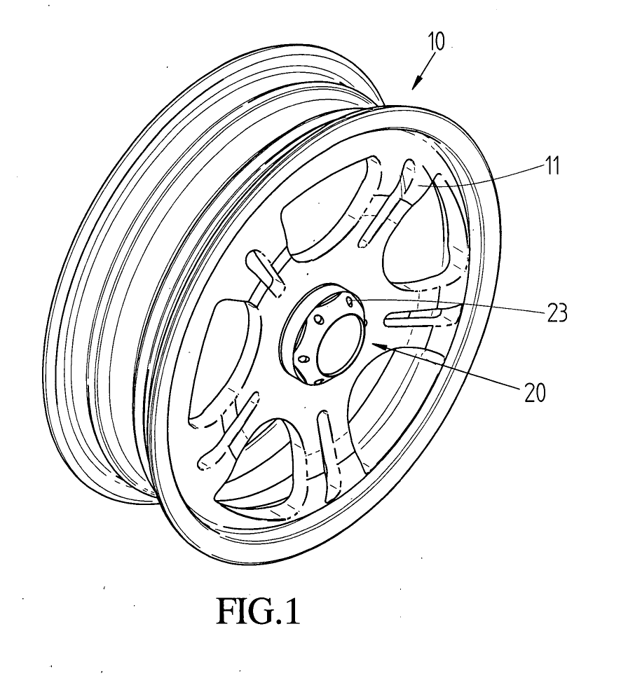

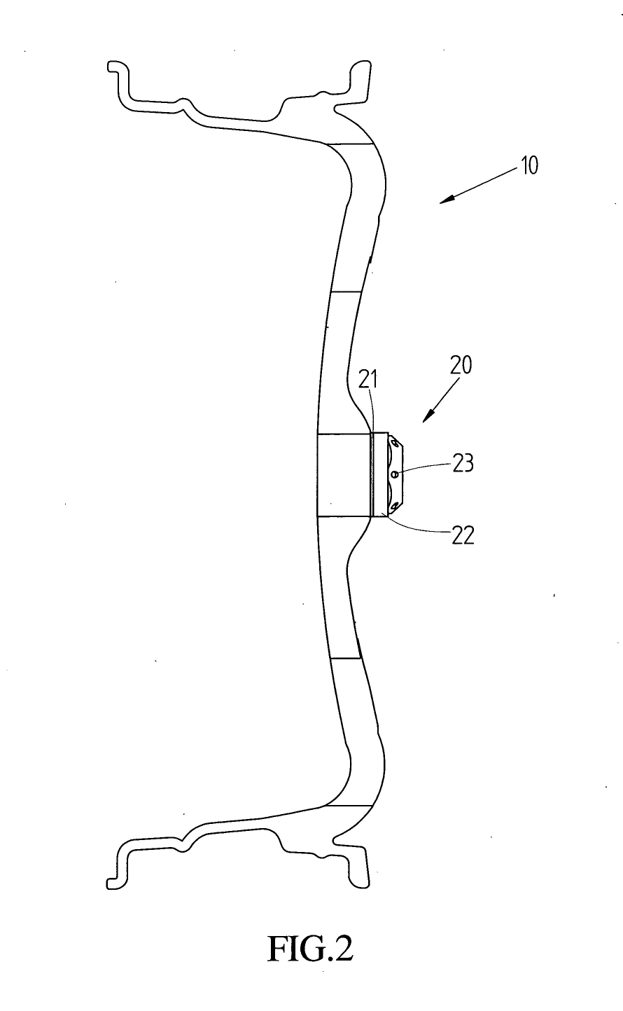

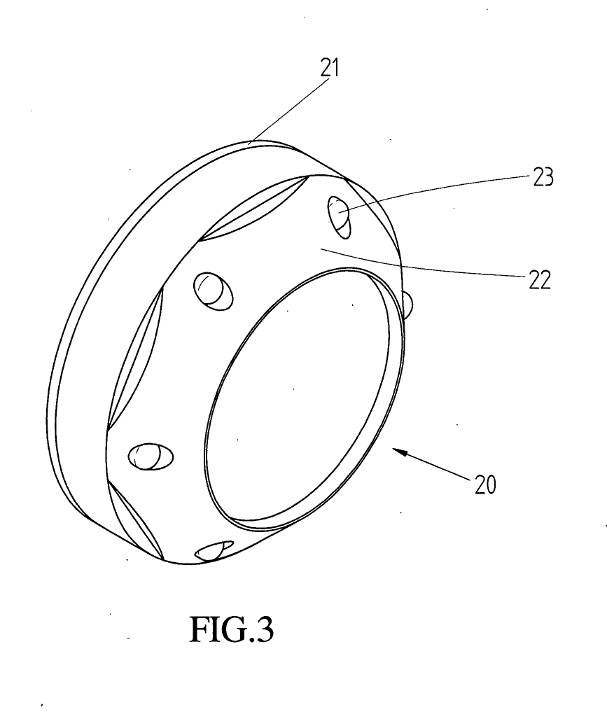

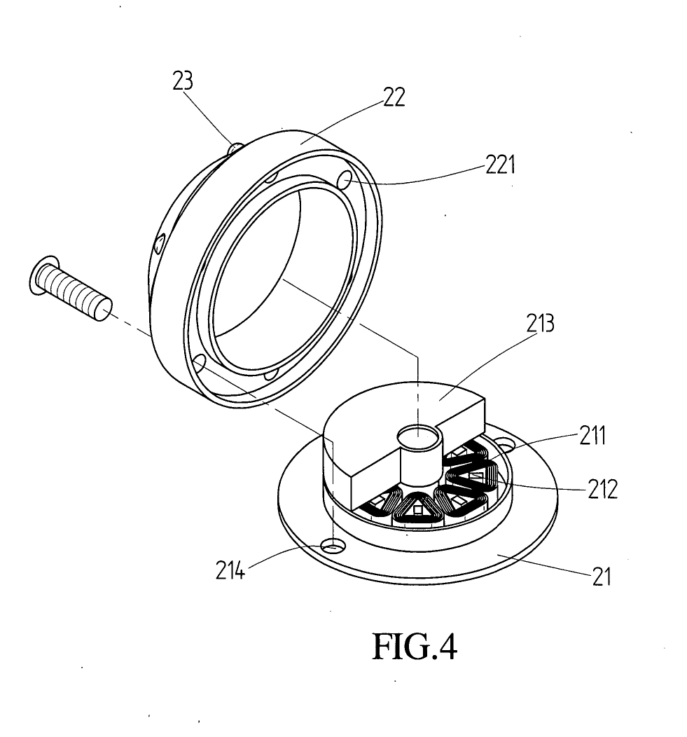

Referring to FIGS. 1 to 4, the wheel rim 10 of the present invention comprises a peripheral engaging portion and a central ring. A plurality of ribs 11 are connected between the central ring and the periphery of the rim 10. A tire (not shown) is mounted onto the peripheral engaging portion. A generator 20 is connected to the central ring and including a base 21 which has coils 211 and electric capacitors 212 connected thereto. A rotatable member 213 which is a magnet is rotatably connected to a central axle of the generator 20 so as to activate the coils 211 to produce electric power. A cover 22 is mounted onto the base 21 and includes a plurality of first holes 221 and the base 21 includes a plurality of second holes 214 so that bolts extend through the first and second holes 221, 214 to fix the generator 20 to the rim 10. A plurality of light emitting diodes (LEDs) 23 are connected to the cover 22 and electrically connected to the generator 20.

When the rim is rotated, the rotatable member 213 is rotated across the coils 211 and capacitors 212 so that the change of magnetic fields is transferred to be electric power and the LEDs 23 are powered to emit light. The light is obvious during dark area.

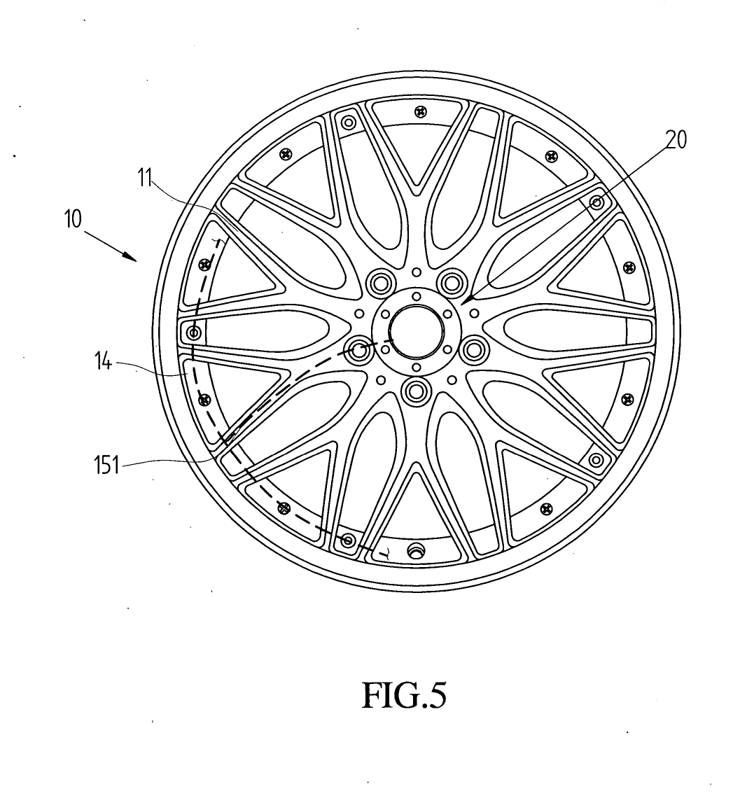

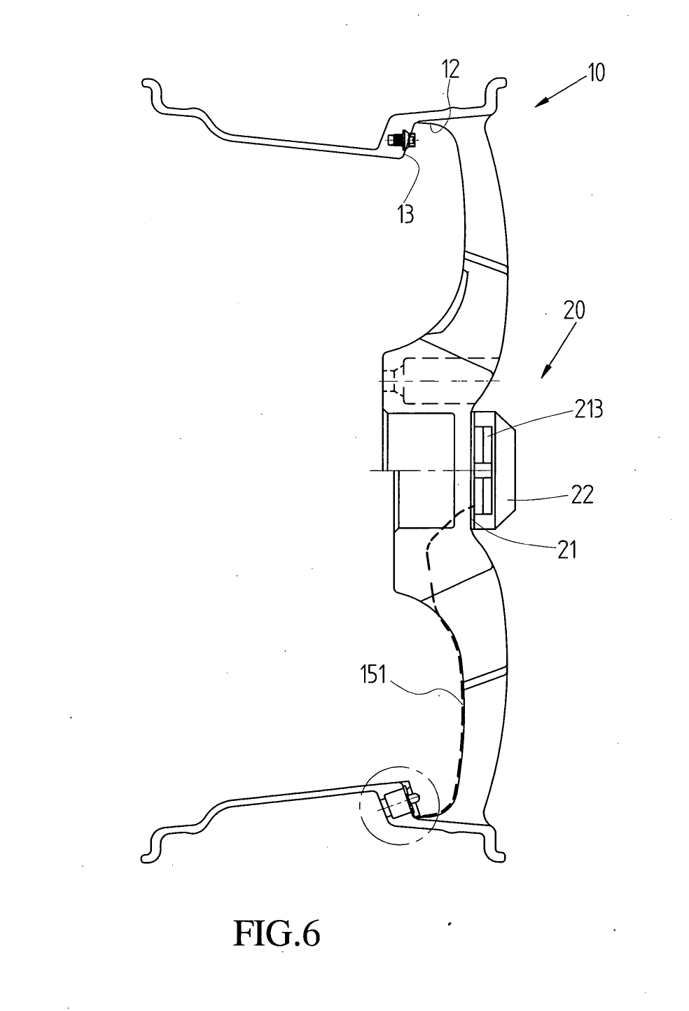

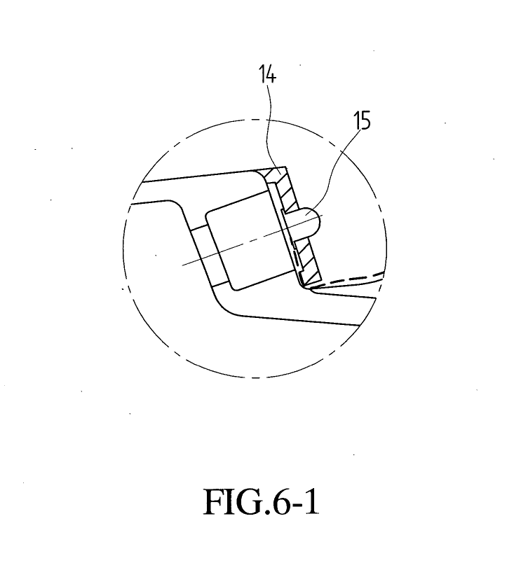

Referring to FIGS. 5, 6 and 6-1, a second embodiment of the rim 10 includes a groove 12 defined in the inner periphery of the engaging protrusion so as to form a surface 13 which partially defines the groove 12. A plurality of LEDs 15 are fixed on the surface 13 and a plate 14 is mounted to the surface 13 and the LEDs 15 extend through the plate 14. Wires 151 are connected between the LEDs 15 and the generator 20 are hidden by the plate 14. The LEDs 15 are arranged so that they can be seen between the ribs 11 and can be protected from being hit by foreign objects by the ribs 11.

While we have shown and described the embodiment in accordance with the present invention, it should be clear to those skilled in the art that further embodiments may be made without departing from the scope of the present invention.

What is claimed is:

1. A wheel rim comprising:
a peripheral engaging portion and a central ring, a plurality of ribs connected between the central ring and the peripheral engaging portion of the rim, a generator connected to the central ring and including a base which has coils and electric capacitors, a rotatable member rotatably connected to a central axle of the generator so as to activate the coils to produce electric power, a cover is mounted onto the base, and
a plurality of light emitting diodes (LEDs) connected to the rim and electrically connected to the generator.

2. The wheel rim as claimed in claim 1, wherein a plurality of LEDs are connected to the cover.

3. The wheel rim as claimed in claim 1, wherein the cover includes a plurality of first holes and the base includes a plurality of second holes so that bolts extend through the first and second holes to fix the generator to the rim.

4. The wheel rim as claimed in claim 1, wherein the engaging protrusion includes a groove defined in an inner periphery thereof so as to form a surface which partially defines the groove, a plurality of LEDs are fixed on the surface.

5. The wheel rim as claimed in claim 4, wherein a plate is mounted to the surface and the LEDs extend through the plate, wires connected between the LEDs and the generator are hidden by the plate.

6. The wheel rim as claimed in claim 1, wherein the rotatable member is a magnet.
